(19) United States
(12) Patent Application Publication
(10) Pub. No.: US 2023/0058274 A1
(43) Pub. Date: Feb. 23, 2023

(54) DIGITAL MEDIA MOCKING TOOL

(71) Applicant: Kyle Saldivar, West Hollywood, CA (US)

(72) Inventor: Kyle Saldivar, West Hollywood, CA (US)

(21) Appl. No.: 17/409,034

(22) Filed: Aug. 23, 2021

(51) Int. Cl. G06Q 30/02; G06F 16/958; H04L 29/08; G06F 40/106

(52) U.S. Cl. CPC G06Q 30/0242; G06F 16/986; H04L 67/34; G06F 40/106

(57) ABSTRACT

Described herein are methods, systems, and media for mocking a digital channel page for testing an advertising creative on the digital channel page. An exemplary method includes receiving, at a mock application running on a server and from a client device, an address of the digital channel page, an advertising creative, and desired dimensions of the advertising creative in the digital channel page; and retrieving source code of the digital channel page based on the address, the digital channel page including an advertising space. The method further includes locating the advertising space in the digital channel page; injecting the advertising creative into the advertising space in the source code of the digital channel page with the desired dimensions; and sending the source code of the digital channel page to the client device for display.

### TECHNICAL FIELD

Embodiments of the present disclosure are generally related to digital advertising, and are particularly related to a digital mocking tool for mocking digital advertising creatives before placing them in target digital channel pages (e.g. websites).

### BACKGROUND

Digital advertising refers to advertising delivered through digital channels. Typically, advertisers promote their products, services, or events using creatives placed in the digital channels. For its creatives to reach a large audience, many advertisers use outside digital advertising placement specialists to place the creatives on the target digital channels, e.g., websites. An outside digital advertising placement specialist (hereinafter placement specialist) also needs to promote their placement services to potential advertisers.

In today's digital advertising industry, a placement specialist who wants to sell a campaign to a potential advertiser often needs to find a creative relevant to the products, services or events of the advertiser, photoshop the creative into a specific advertising unit to match an advertising space on a particular target channel page, and show the potential advertiser what the creative would look like. After the campaign is sold and the placement specialist is hired, the placement specialist would need to use a creative provided by the advertiser, and photoshop it for the advertising space on the target digital channel page where the creative is to be placed.

The above process of manually customizing a creative for a particular advertising space on a target channel page is inefficient and time-consuming, particularly when the creative is to be placed on a large number of digital channels. Further, the placement specialist has no way to show a potential advertiser what the creative would look like in the digital channel page without actually placing the creative in the digital channel page.

### SUMMARY

Described herein are methods, systems, and media for mocking a digital channel page for testing an advertising creative on the digital channel page. An exemplary method includes receiving, at a mock application running on a server and from a client device, an address of the digital channel page, an advertising creative, and desired dimensions of the advertising creative in the digital channel page; and retrieving source code of the digital channel page based on the address, the digital channel page including an advertising space. The method further includes locating the advertising space in the digital channel page; injecting the advertising creative into the advertising space in the source code of the digital channel page with the desired dimensions; and sending the source code of the digital channel page to the client device for display.

### BRIEF DESCRIPTION OF THE DRAWINGS

The figures of the accompanying drawings provide examples of embodiments. Like references indicate similar elements.

FIG. 1 illustrates a system for mocking a digital channel page according to one embodiment.

FIG. 2 further illustrates the system for mocking a digital channel page according to one embodiment.

FIG. 3 illustrates an example of a management interface according to one embodiment.

FIG. 4 is a flow chart illustrating a process of mocking a digital channel according to one embodiment.

FIG. 5 is a block diagram of an example computing device that may perform operations of one or more embodiments described herein, according to some embodiments.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to various embodiments, described herein are methods, systems, and media for mocking a digital channel page for testing an advertising creative on a target digital channel page. In one exemplary embodiment, a method includes the operations of receiving, at a mock application running on a server and from a client device, an address of the digital channel page, an advertising creative, and desired dimensions of the advertising creative in the digital channel page; and retrieving, by the mocking application, source code of the digital channel page based on the address, the digital channel page including an advertising space. The method further includes locating, by the mocking application, the advertising space in the digital channel page; injecting, by the mocking application, the advertising creative into the advertising space in the source code of the digital channel page with the desired dimensions; and sending, by the mocking application, the source code of the digital channel page to the client device for display.

In one embodiment, prior to the injecting of the advertising creative into the advertising space, deleting, by the mocking application, an existing creative in the advertising space in the source code.

In one embodiment, the digital channel page is a webpage, and the source code of the digital channel page is hypertext markup language (HTML). The identifiers of the advertising space are a pair of HTML image tags, a pair of HTML video tags, or a pair of HTML object tags.

In one embodiment, the retrieving of the source code of the digital channel page further includes invoking a command line tool to retrieve the source code using one of a plurality of protocols, including hypertext transfer protocol (HTTP), file transfer protocol (FTP), internet message access protocol (IMAP), post office protocol 3, secured copy protocol (SCP), and secure file transfer protocol (SFTP).

In one embodiment, the dimensions of the advertising creative received from the client device is equal to or smaller than actual dimensions of the advertising creative. The advertising space is one of a plurality of advertising spaces in the digital channel page, each advertising space with different dimensions and matching the advertising creative in terms of media type, and the advertising space has dimensions closest to the desired dimensions among the plurality of advertising spaces.

As such, embodiments of the invention allow a user to select or specify a desired size for a creative of any media type, input an address of a digital channel page to be mocked on, and then upload the creative to a server where the digital media mocking application (also referred to as a digital media mocking tool) is running. The digital media mocking application can automatically resize the creative to match the size of an advertising space in the digital channel page. The user does not need to own the digital channel page in order to mock the creative thereon. The mocking application completely eliminates the need for the user to photoshop the creative for mocking the digital channel page.

The above summary does not include an exhaustive list of all embodiments in this disclosure. All systems and methods can be practiced from all suitable combinations of the various aspects and embodiments described in the disclosure.

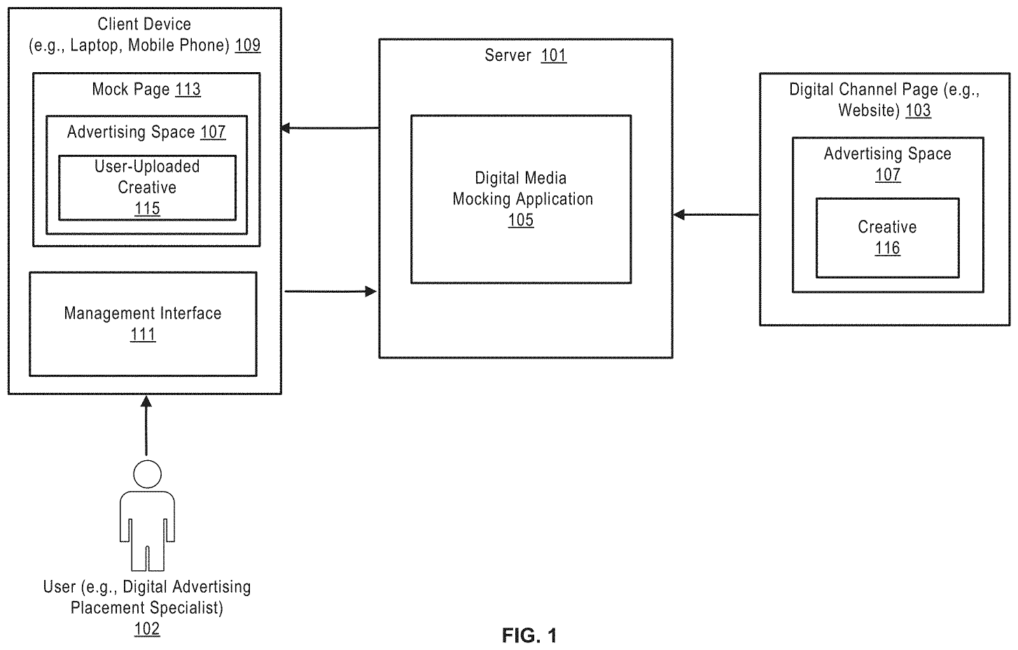

FIG. 1 illustrates a system for mocking a digital channel page according to one embodiment. As shown in FIG. 1, a digital media mocking application 105 can be installed on a server 101, which can interact with a client device 109 and a digital channel page 103. The client device 109 can be any type of clients such as a host or server, a personal computer (e.g., desktops, laptops, and tablets), a “thin” client, a personal digital assistant (PDA), a Web enabled appliance, or a mobile phone (e.g., Smartphone), etc. The server 101 can any kinds of servers, for example, Web servers, application servers, cloud servers, backend servers, etc.

The digital media mocking application 105 can include a graphical user interface (GUI) component that generates a management interface 111 and a mock page 113 for display on the client device 109. The management interface 109 enables a user 102 to upload an advertising creative 115 to the server 101, and also enables the user to specify an addresses of the digital channel page 103 on which the digital media mocking application is to mock. Examples of the digital channel page 103 can include a page on a plurality of digital channels, such as search engine, a website, a social media site, an email application, or a mobile application. An example of the address of the digital channel page is a uniform resource locator (URL) of the digital channel page.

In one embodiment, the user-uploaded advertising creative 115 is a digital media artifact relevant to a potential advertiser's products, services, or events, and can be an image, a video clip, audio clip, and other types of media. The user 102 can be any type of users, such as an in-house digital advertising placement specialist, and an outside digital advertising placement specialist.

Further, the management interface 111 enables the user to specify or select desired dimensions of the user-uploaded advertising creative 115 in the mock page 113, which is to be displayed on the client device 109.

In an example use case, the user 102 can determine to mock the digital channel page 103 with the creative 115 before pitching an advertising campaign to a potential advertiser. The user 102 can obtain the creative 115, and the address of the digital channel page 103, and then can upload the creative 115 via the management interface 111, where the user can input the address of the digital channel page 103, and specify or select desired attributes (e.g., dimensions) of the creative 105 in the mock page 113. When the user clicks on a “Submit” button on the management interface 111, the digital media mocking application can obtain the address of the digital channel page 103, the uploaded creative 115, the desired attributes of the creative 115; retrieve source code of the digital channel page 103; locate an advertising space 107 in the source code based on advertising space identifiers (e.g., HTML image tags); and replace the uploaded advertising creative 115 with whatever is embedded in the advertising space 107, including an existing creative 116 therein; and generate the mock page 113 with the advertising space 107, which contains the uploaded creative 115 with the desired dimensions; and send the generated mock page 113 to the client device 109 for display. The user 102 can show the potential advertiser the mock page 113 as part of his or her pitching efforts.

In one embodiment, the advertising space 107 is a designated area for displaying an advertising creative on a digital channel page. Thus, if there is an existing creative in an advertising space, the existing creative and the adverting space are used interchangeably, namely, the attributes of the advertising space and the existing creative are the same.

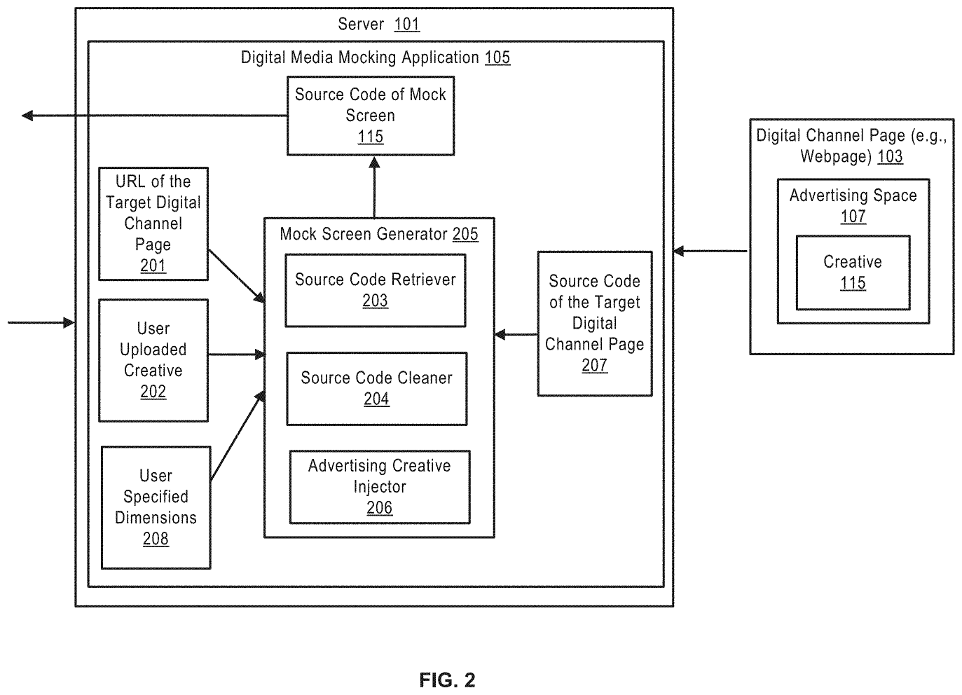

FIG. 2 further illustrates the system for mocking a digital channel page according to one embodiment. More specifically, FIG. 2 further illustrates the digital media mocking application 105.

As shown in FIG. 2, the digital media mocking application 105 can include a mock screen generator 205 with a source code retriever 203, a source code cleaner 204 and an advertising creative injector 206.

In one embodiment, the source code retriever 203 can retrieve source code of the digital channel page 207 using a command line tool (e.g., a CURL tool) based on a URL of the target digital channel page 201 using one of a plurality of protocols, including hypertext transfer protocol (HTTP), file transfer protocol (FTP), internet message access protocol (IMAP), post office protocol 3, secured copy protocol (SCP), and secure file transfer protocol (SFTP).

In one example, the source code 207 can be HTML source code, with the advertising space 107 marked by a pair of HTML image tags, a pair of HTML video tags, or a pair of HTML object tags. The HTML image tags are used to embed various types of images in the source code 207, the HTML video tags are used to embed a video clip in the source code 207, and the HTML object tags are used to embed multimedia files such as audio, video, flash, PDF, ActiveX, and Java Applets in the source code 207. Each pair of tags have attributes, including dimension attributes specifying the size of an advertising creative embedded within the pair of tags.

The source code cleaner 204, which can be a custom script, can search through the source code 207, and locate the identifying tags for the advertising space 107, and determine if there is any existing creative within the identifying tags. If there is an existing creative, the source code retriever 204 can remove the existing creative, and clear the values of the dimensions of the existing creative. In this embodiment shown in FIG. 2, there is an existing creative (i.e., the creative 115) in the advertising space 107, and therefore, the source code cleaner 204 would remove the creative 115 and clear the values of the dimensions of the creative 115, with values of the rest of the attributes of the existing creative 115 untouched.

The advertising creative injector 206, which can be a module in the custom script described above or a separate custom script, can inject a user uploaded creative 202 into the advertising space 107, and change the values of the dimensions of the creative 202 to user specified dimensions 208.

In one embodiment, the desired dimensions 208 cannot be larger than the actual dimensions of the creative 202, which means that the dimensions need to be equal to or smaller than dimensions of the advertising creative 202. The purpose of such a requirement is to ensure that the creative 202 would not be stretched or distorted when appearing in a mock screen on a client device.

After injecting the user uploaded creative 202 with the specified dimensions 208 into the advertising space 107, the mock screen generator 205 can output a source code 115 of a mock screen, which can be sent to a client device for display.

In one embodiment, the mock screen generator 205 can automatically determine a media type of the user uploaded creative 202, and determine whether such a media type matches the media type specified by the identifying tags of the advertising space 107. If the media type of the user uploaded creative 202 matches the media type required by the advertising space 107, the mock screen generator 205 can inject the user uploaded creative 202 into the advertising space 107 according to the operations described above. Otherwise, the mock screen generator 205 can output an error message to the client device, indicating that a creative of an incorrect media type has been uploaded.

For example, if the identifying tags of the advertising space 107 are image tags, while the user uploaded creative is a video clip, the mock screen generator 205 would generate a message indicating that an incorrect type of creative has been uploaded. In such a case, no mock screen would be generated.

In one embodiment, the user typically would have examined the digital channel page 103, and has learned that there is at least one advertising space on that digital channel page 103 that requires a media type that the user plans to test.

In one embodiment, if at least two advertising spaces on the digital channel page 103 require the same type of creative, the mock screen generator 205 can inject the user uploaded creative 202 into an advertising space with dimensions that are closest to the user specified dimensions. The mock screen generator 205 can compare the user specified dimensions 208 and the dimensions of each advertising space based on their length-width ratios to determine which advertising space to host the user uploaded creative 202.

For example, for a creative with an actual size of 800×600 pixels and a desired size of 800×600 pixels, the mock screen generator 205 would select an advertising space with a size of 400×300 pixels over an advertising space with a size of 700×200 pixels because the length-width ratio of the selected advertising space is closer to that of the desired size of the creative than the other advertising space.

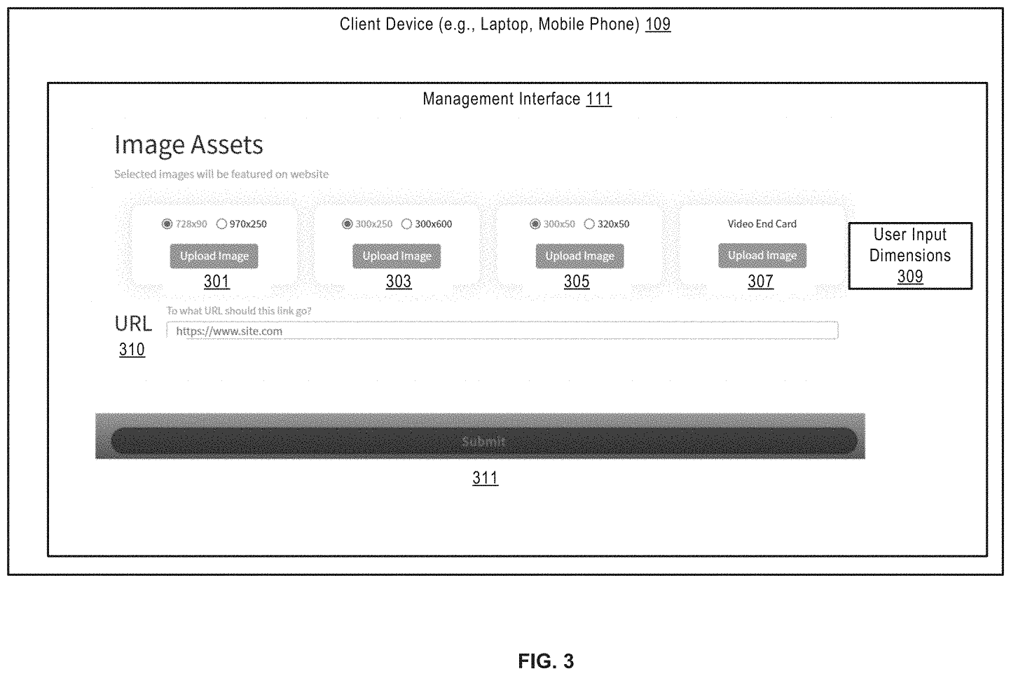

FIG. 3 illustrates an example of the management interface 111 according to one embodiment. As shown in FIG. 3, the management interface 111 can include a number of options 301, 303, and 305 for a user to select dimensions for an image to be uploaded. The management interface 111 further include a user input dimensions field 309 where a user to input any dimensions as long as they do not expand the creative to be uploaded.

The management interface 111 is provided for illustration purposes. Thus, although the management interface 111 allows a user to upload only images and video clips, other media types, such as PDF, can be uploaded via the management interface 111 in actual implementations.

In one embodiment, the user can simultaneously upload multiple images with desired dimensions for each to test the images on a single digital channel page specified by a single URL. In such a case, the mock screen generator 205 described in FIG. 2 would generate multiple mock screens, each mock screen with a different image with its corresponding desired dimensions. All the mock screens would be sent to the client device for display.

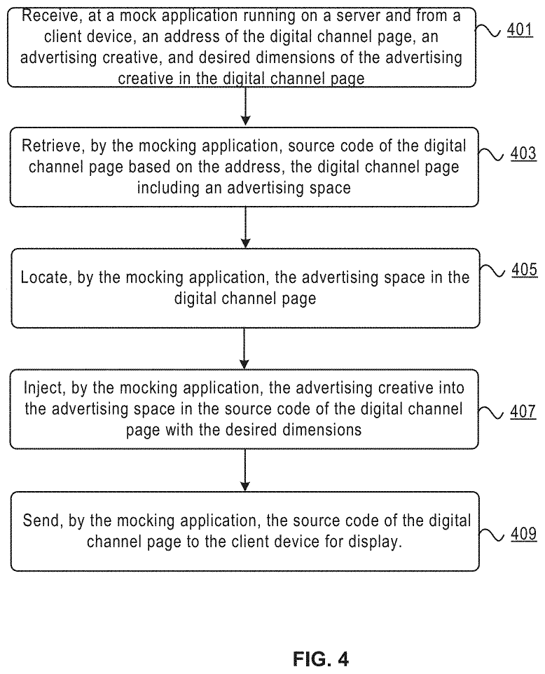

FIG. 4 is a flow chart illustrating a process of mocking a digital channel page for testing an advertising creative according to one embodiment. The process may be performed by a processing logic which may include software, hardware, or a combination thereof. For example, the processing logic may be performed by the digital media mocking application 105 as described in FIG. 1 and FIG. 2.

As shown in FIG. 4, in operation 401, the processing logic receives an address of the digital channel page, an advertising creative, and desired dimensions of the advertising creative in a target digital channel page. The address can be a URL of the target digital channel page, and an example of the digital channel page can be a webpage.

In operation 403, the processing logic receives source code of the digital channel page based on the address, the digital channel page including an advertising space. In one implementation, the source of the digital channel page can be HTML source code, and can be retrieved using a CURL command line tool.

In operation 405, the processing logic can search through the HTML source code, and locate the advertising space in the digital channel page based on a matching between a media type of the creative and the identifying tags of the advertising space.

In operation 407, the processing logic injects the advertising creative into the advertising space in the source code of the digital channel page with the desired dimensions. In this operation, before injecting the advertising creative received from the client device, the processing logic can first determine whether there is an existing creative embedded between the identifying tags, and if there is one, the processing logic can delete the existing creative, and values of the dimension attributes associated with the identifying tags.

In operation 409, the processing logic sends the source code of the digital channel page to the client device for display. The source code sent to the client device includes the advertising creative with desired dimensions specified by a user.

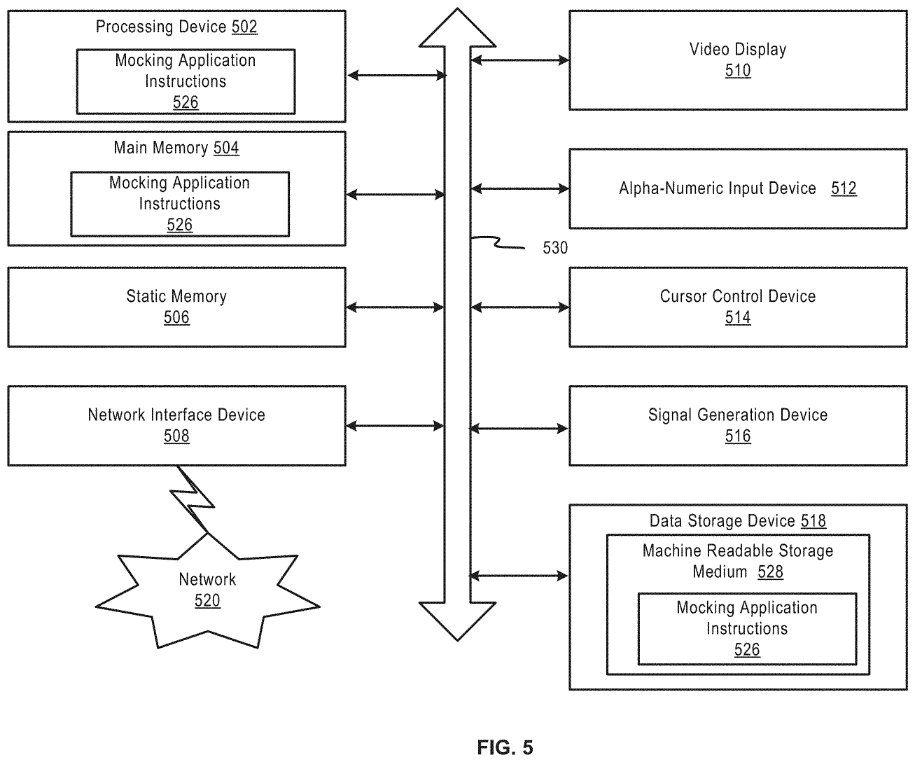

FIG. 5 is a block diagram of an example computing device that may perform operations of one or more embodiments described herein, according to some embodiments. The computing device may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device may include a processing device (e.g., a general purpose processor, a PLD, etc.) 502, a main memory 504 (e.g., synchronous dynamic random access memory (DRAM), read-only memory (ROM)), a static memory 506 (e.g., flash memory and a data storage device 518), which may communicate with each other via a bus 530.

Processing device 502 may be provided by one or more general-purpose processing devices such as a microprocessor, central processing unit, or the like. In an illustrative example, processing device 502 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also comprise one or more special-purpose processing devices such as an application specific integrated circuit (ASIC), a field programmable gate array (FPGA), a digital signal processor (DSP), network processor, or the like. The processing device 502 may be configured to execute the operations described herein, in accordance with one or more aspects of the present disclosure, for performing the operations and operations discussed herein.

The computing device may further include a network interface device 508 which may communicate with a network 520. The computing device also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Data storage device 518 may include a computer-readable storage medium 528 on which may be stored one or more sets of instructions, e.g., company profile graphing instructions for carrying out the operations described herein, in accordance with one or more aspects of the present disclosure. Mocking application instructions 526 may also reside, completely or at least partially, within main memory 504 and/or within processing device 502 during execution thereof by the computing device, main memory 504 and processing device 502 also constituting computer-readable media. The company profile graphing instructions may further be transmitted or received over a network 520 via network interface device 508.

While computer-readable storage medium 528 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus or a system for performing the operations described herein. This apparatus or system may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method operations. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component.

Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. The described functionality may be implemented in various ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

For one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable one to make or use the methods, systems, and apparatus of the present disclosure. Various modifications to these embodiments will be readily apparent, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method of mocking a digital channel page for testing an advertising creative, comprising:
receiving, at a mock application running on a server and from a client device, an address of the digital channel page, an advertising creative, and desired dimensions of the advertising creative in the digital channel page;
retrieving, by the mocking application, source code of the digital channel page based on the address, the digital channel page including an advertising space;
locating, by the mocking application, the advertising space in the digital channel page;
injecting, by the mocking application, the advertising creative into the advertising space in the source code of the digital channel page with the desired dimensions; and
sending, by the mocking application, the source code of the digital channel page to the client device for display.

2. The method of claim 1, further comprising:
prior to the injecting of the advertising creative into the advertising space, deleting, by the mocking application, an existing creative at the advertising space in the source code.

3. The method of claim 1, wherein the digital channel page is a webpage, and the source code of the digital channel page is hypertext markup language (HTML).

4. The method of claim 3, wherein the identifiers of the advertising space are a pair of HTML image tags, a pair of HTML video tags, or a pair of HTML object tags.

5. The method of claim 1, wherein the retrieving of the source code of the digital channel page based on the address further comprises:
invoking a command line tool to retrieve the source code using one of a plurality of protocols, including hypertext transfer protocol (HTTP), file transfer protocol (FTP), internet message access protocol (IMAP), post office protocol 3, secured copy protocol (SCP), and secure file transfer protocol (SFTP).

6. The method of claim 1, wherein the dimensions of the advertising creative received from the client device is equal to or smaller than actual dimensions of the advertising creative.

7. The method of claim 1, wherein the advertising space is one of a plurality of advertising spaces in the digital channel page, each advertising space with different dimensions and matching the advertising creative in terms of media type, wherein the advertising space has dimensions closest to the desired dimensions among the plurality of advertising spaces.

8. A non-transitory machine-readable medium storing executable computer program instructions for mocking a digital channel page for testing an advertising creative, the program instructions, when executed by a processor, causes the processor to perform operations, the operations comprising:
receiving, at a mock application running on a server and from a client device, an address of the digital channel page, an advertising creative, and desired dimensions of the advertising creative in the digital channel page;
retrieving, by the mocking application, source code of the digital channel page based on the address, the digital channel page including an advertising space;
locating, by the mocking application, the advertising space in the digital channel page;
injecting, by the mocking application, the advertising creative into the advertising space in the source code of the digital channel page with the desired dimensions; and
sending, by the mocking application, the source code of the digital channel page to the client device for display.

9. The non-transitory machine-readable medium of claim 8, the operations further comprising:
prior to the injecting of the advertising creative into the advertising space, deleting, by the mocking application, an existing creative at the advertising space in the source code.

10. The non-transitory machine-readable medium of claim 8, wherein the digital channel page is a webpage, and the source code of the digital channel page is hypertext markup language (HTML).

11. The non-transitory machine-readable medium of claim 10, wherein the identifiers of the advertising space are a pair of HTML image tags, a pair of HTML video tags, or a pair of HTML object tags.

12. The non-transitory machine-readable medium of claim 8, wherein the retrieving of the source code of the digital channel page based on the address further comprises:
invoking a command line tool to retrieve the source code using one of a plurality of protocols, including hypertext transfer protocol (HTTP), file transfer protocol (FTP), internet message access protocol (IMAP), post office protocol 3, secured copy protocol (SCP), and secure file transfer protocol (SFTP).

13. The non-transitory machine-readable medium of claim 8, wherein the dimensions of the advertising creative received from the client device is equal to or smaller than actual dimensions of the advertising creative.

14. The non-transitory machine-readable medium of claim 8, wherein the advertising space is one of a plurality of advertising spaces in the digital channel page, each advertising space with different dimensions and matching the advertising creative in terms of media type, wherein the advertising space has dimensions closest to the desired dimensions among the plurality of advertising spaces.

15. A data processing system, comprising:
a processor; and
a memory coupled to the processor to store instructions, which when executed by the processor, cause the processor to perform operations of mocking a digital channel page for testing an advertising creative, the program instructions, when executed by a processor, causes the processor to perform operations, the operations comprising:
receiving, at a mock application running on a server and from a client device, an address of the digital channel page, an advertising creative, and desired dimensions of the advertising creative in the digital channel page;
retrieving, by the mocking application, source code of the digital channel page based on the address, the digital channel page including an advertising space;
locating, by the mocking application, the advertising space in the digital channel page;
injecting, by the mocking application, the advertising creative into the advertising space in the source code of the digital channel page with the desired dimensions; and
sending, by the mocking application, the source code of the digital channel page to the client device for display.

16. The system of claim 15, the operations further comprising:
prior to the injecting of the advertising creative into the advertising space, deleting, by the mocking application, an existing creative at the advertising space in the source code.

17. The system of claim 15, wherein the digital channel page is a webpage, and the source code of the digital channel page is hypertext markup language (HTML).

18. The system of claim 17, wherein the identifiers of the advertising space are a pair of HTML image tags, a pair of HTML video tags, or a pair of HTML object tags.

19. The system of claim 15, wherein the retrieving of the source code of the digital channel page based on the address further comprises:
invoking a command line tool to retrieve the source code using one of a plurality of protocols, including hypertext transfer protocol (HTTP), file transfer protocol (FTP), internet message access protocol (IMAP), post office protocol 3, secured copy protocol (SCP), and secure file transfer protocol (SFTP).

20. The system of claim 15, wherein the dimensions of the advertising creative received from the client device is equal to or smaller than actual dimensions of the advertising creative.
